(19) United States
(12) Patent Application Publication
(10) Pub. No.: US 2011/0069394 A1
(43) Pub. Date: Mar. 24, 2011

(54) LENS ARRAY IMAGE

(76) Inventor: Eric C. Stelter, Pittsford, NY (US)

(21) Appl. No.: 12/564,121

(22) Filed: Sep. 22, 2009

(51) Int. Cl. G02B 27/10

(52) U.S. Cl. 359/619

(57) ABSTRACT

A lens array image includes a substrate, a first lens on a first side of the substrate, and a second lens on the first side of the substrate. The first and second lenses form a lens array. Respective first image segments are at the second side of the substrate. Each of the first image segments is in focus when viewed from a first viewing angle through a respective one of the first and second lenses. Respective second image segments are at a second side of the substrate. Each of the second image segments is in focus when viewed from a second viewing angle through a respective one of the first and second lenses. At least a portion of each of the first image segments is on a first plane. At least a portion of the respective second image segments is on a second plane. The first plane is different than the second plane.

### FIELD OF THE INVENTION

This invention relates in general to electrographic printing, and more particularly to printing of raised toner to form one or more optical elements by electrography.

### BACKGROUND OF THE INVENTION

The present invention relates to images incorporating a lens array. It finds particular application in conjunction with printing an image, incorporating a lens array, on a multi-planar or curved surface and will be described with particular reference thereto. It will be appreciated, however, that the invention is also amenable to other applications.

Lens array images include motion images, lenticular images, and integral images. One embodiment of a motion image includes a non-planar (e.g., folded) substrate having two images, with alternating narrow segments of each image printed side by side. This type of motion image is also referred to as a folded image. A lenticular image includes a planar substrate with interdigitated segments of at least two images adjacent a lens array that focuses on a first image at a first viewing angle and focuses on a second image at a second viewing angle. An integral image includes an array of spherical lenses, each having a separate, single image representing the light that would be projected to an observer from a location in the array so that a 3-D display is created.

Although motion (folded) images produce good separation between images, the images may be difficult to produce and handle during manufacturing. Additionally, the width of the image segments used in folded images must be larger than a width of a crease in the image segment (e.g., approximately the thickness of the substrate). Folded images are commonly limited to containing two interdigitated images.

Separation between interdigitated segments of lenticular images depends on a first image being in focus when viewed from a first viewing angle and a second image being out of focus when viewed from the first viewing angle. At a second viewing angle, the second image is in focus and the first image is out of focus. However, the second image may be out of focus at all viewing angles unless complicated lens profiles are used. Also, in a lenticular image, when viewing a first image from a first viewing angle, a portion of the second image may be visible. Therefore, lenticular images often include non-distinct separations between the interdigitated segments of the images. Lens arrays used in lenticular imaging may be made mechanically, such as by molding, extrusion or cutting processes. The lenses in the array are usually wide to accommodate mechanical forming and are necessarily thick. Image segments are typically wide to accommodate wide lenses and some misregistration. Therefore, the segments of the first image are often multiple pixels wide, with the second image being similarly sized. In addition, the first and second images must be registered with the lens array.

Integral images may have similar issues as lenticular images. For example, an integral image may be in focus from a first viewing angle, but out of focus from a second viewing angle.

The present invention provides a new and improved apparatus and method which addresses the above-referenced problems.

### SUMMARY OF THE INVENTION

In one aspect of the present invention, a lens array image includes a substrate, a first lens on a first side of the substrate, and a second lens on the first side of the substrate. The first and second lenses form a lens array. Respective first image segments are at the second side of the substrate. Each of the first image segments is in focus when viewed from a first viewing angle through a respective one of the first and second lenses. Respective second image segments are at a second side of the substrate. Each of the second image segments is in focus when viewed from a second viewing angle through a respective one of the first and second lenses. At least a portion of each of the first image segments is on a first plane. At least a portion of the respective second image segments is on a second plane. The first plane is different than the second plane.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a schematic view of a lens array in accordance with several embodiments of an apparatus illustrating principles of the present invention;

FIG. 2 illustrates a schematic view of at least one image printed on parallel planes that intersect or are tangent to loci of foci of the lens array in accordance with one embodiment of an apparatus illustrating principles of the present invention;

FIG. 3 illustrates a schematic view of at least one image printed on planes tangent to the loci of foci of the lens array in accordance with one embodiment of an apparatus illustrating principles of the present invention;

FIG. 4 illustrates a schematic view of at least one image printed on a curved surface substantially in alignment with loci of foci of the lens array in accordance with one embodiment of an apparatus illustrating principles of the present invention.

### DETAILED DESCRIPTION OF THE INVENTION

Motion images are made using non-planar substrates. A common embodiment is a folded image made of a sheet of paper containing two images, with alternating narrow segments of each image printed side by side. The sheet is folded at the edge of each image portion in an alternating concave-convex-concave (et cetera) fashion to produce a folded image so that a first image is seen when the sheet is viewed from the left at a first viewing angle, and a second image is seen only when the sheet is viewed from the right at a second viewing angle.

Lenticular images are made with a planar substrate containing interdigitated segments of at least two and optionally three or more images adjacent a lens array that focuses on a first image at a first viewing angle and focuses on a second image at a second viewing angle. Usually, the first image is visible primarily at a first viewing angle that is 90 degrees or normal to the lens array. The second image is visible primarily at a second viewing angle that is perhaps 30 degrees from normal. Other configurations are possible. For example, the first image can be visible at an angle 15 degrees from normal, and the second image can be visible at an angle −15 degrees from normal. The lenses in the array can be cylindrical lenses that focus on a line or spherical lenses that focus on a dot. Lenses of elliptical cross-section have been used to improve the focus of lenticular images.

Integral images are made with an array of spherical lenses, each having a separate, single image representing the light that would be projected to the observer from that location in the array so that a 3-D display is created.

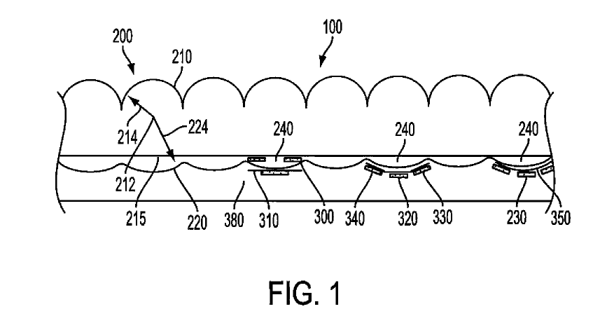

With reference to FIG. 1, a lens array 100, which is illustrated in cross section, includes a plurality of lenses 200. It is contemplated that the lenses 200 in the array 100 are cylindrical or spherical shaped. Each lens 200 has a first (upper) surface 210, a center portion 212, a radius (R₁) 214, a second (lower) surface 215, and a loci of foci 220 with radius (R₂) 224. In the illustrated embodiment, the second (lower) surface 215 is between the first surface 210 and the loci of foci 220. Alternatively, the second (lower) surface 215 may intersect the loci of foci 220 on at least one point. In one embodiment, at least one image 230 (e.g., a color image) is printed on multiplanar or curved surfaces that are registered with the loci of foci and intersect or are tangent to the loci of foci on at least one point in the image so that, for example, either: surfaces 300 and 310 intersect or are tangent to the loci of foci, or cross the loci of foci; surfaces 320, 330, and 340 are tangent to the loci of foci; or surface 350 is curved and substantially in alignment with the loci of foci. In one embodiment, the surfaces 300, 310, 320, 330, 340, and 350 are on a separation layer of toner (e.g., a separation layer of transparent or clear tone), and the at least one image consists of colored toner optionally including a backing layer 380 of another color (e.g., white) or clear toner, as discussed in more detail below. In the illustrated embodiment, a backing layer 380 of white or clear toner is included on the lens array 100.

The focal length of a spherical or cylindrical lens 200 is found by simple ray tracing with Snell's law and is well known to be a distance L from the outer surface of the lens, where:

$$L = {R}_{1} \frac{{n}_{2}}{{n}_{2} - {n}_{1}} \qquad Eq . 1$$

and n₂ is the index of refraction of the lens material, n₁ is the index of refraction of the medium (e.g., air) adjacent the first or upper surface 210 of the lens and outside the lens, and R₁ is the radius of the lens array 214 at the point where the ray enters the lens. In FIG. 1, the focal length L is the distance from the upper surface of the lens 210 along a radius R₁ through the center 212 and then along a radius R₂ to the loci of foci 220.

Electrophotographic printers containing at least 4 or 5 print units and capable of printing a layer of clear toner are known as discussed in US2009/0016757 and incorporated by reference. It is contemplated that a digital printer capable of 6 colors (e.g., including cyan, magenta, yellow, black, clear, and white) could also be used in one embodiment; alternatively a printer capable of duplex printing with excellent registration could be used for printing images in another embodiment of the present invention. It is also contemplated in that embodiment, the printer could print a first side of the substrate with at least 2 passes through the printer, and similarly also print a second side of the substrate.

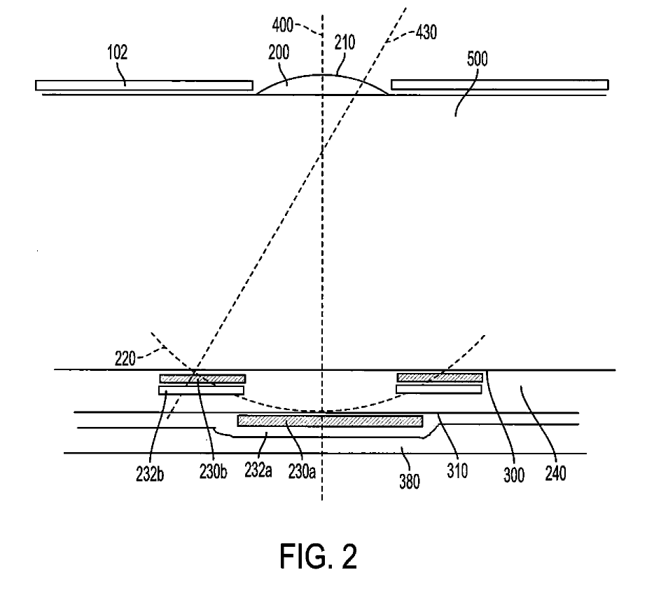

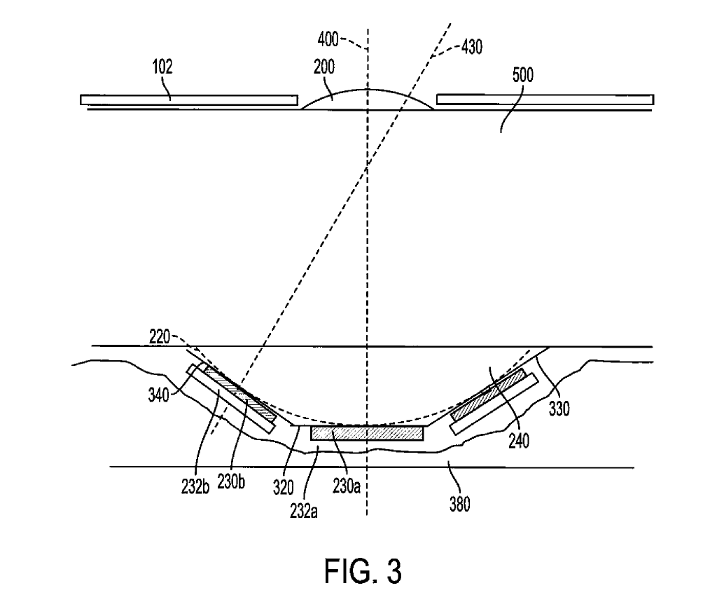

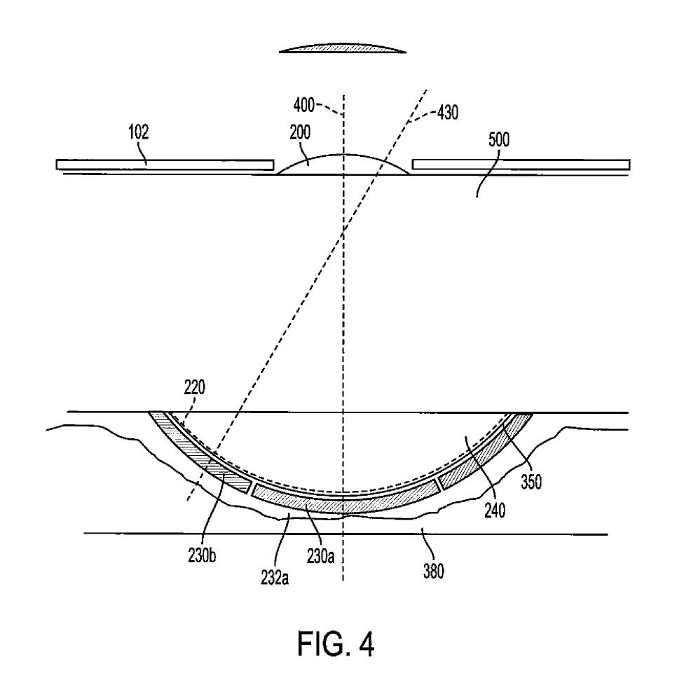

In the embodiments shown in FIG. 2, FIG. 3, and FIG. 4, for example, a lens array image 230 includes a substrate 500, a first lens 200 on a first side of the substrate 500, and a second lens 200 on the first side of the substrate 500. For ease of understanding, the embodiments illustrated in FIG. 2, FIG. 3, and FIG. 4, like components are designated by like numerals. The first and second lenses 200 form the lens array 100. Respective second image segments 230b are positioned at a second side of the substrate 500. Each of the second image segments 230b is in focus when viewed from a second viewing angle 430 through a respective one of the first and second lenses 200. Respective first image segments 230a are positioned at the second side of the substrate 500. Each of the first image segments 230a is in focus when viewed from a first viewing angle 400 through a respective one of the first and second lenses 200. At least a portion of each of the first image segments 230a is on a first plane 310, 320, 350, and at least a portion of the respective second image segments 230b is on a second plane 300, 330, 340, 350. The first plane 310, 320, 350 is different than the second plane 300, 330, 340, 350. With reference to FIG. 4, although the surface 350 is curved, different portions of the curved surface 350 may be viewed as defining respective planes. More specifically, a small portion of the curved surface 350 may be viewed as defining a plane. In that sense, at least a portion of each of the first image segments 230a is on a first plane 350 (e.g., a first portion of the surface 350 that defines a plane), and at least a portion of the respective second image segments 230b is on a second plane 350 (e.g., a second portion of the surface 350 that defines a plane).

Various examples are illustrated in FIG. 2, FIG. 3, and FIG. 4. The illustrated examples assume a pixel size of 42.33 microns corresponding to 600 dpi resolution, a first viewing direction 400 normal to the lens array ±15 degrees, and a second viewing direction 430 30 degrees from normal ±15 degrees, for images and lenses printed on the substrate 500 (e.g., a transparent polyester substrate) with toner (e.g., polyester toner). For ease of understanding the embodiments illustrated in FIG. 2, FIG. 3, and FIG. 4, like components are designated by like numerals in those figures. The index of refraction n₂ is approximately 1.55 for polyester, and n₁ in this example is taken to be 1. Dimensions for an image made with a lens approximately 3×3 pixels in size, 5×5 pixels, or 7×7 pixels are shown in Table 1. The width of the lens 200 corresponds in these examples to a maximum range in viewing angle of ±45 degrees from normal; however, a larger or smaller range of viewing angle is also contemplated. In these examples, L=R₁+R₂=R₁×2.81818 . . . . The sum of the lens height, substrate thickness, and total thickness of a clear layer 240 must equal L, where the clear layer 240 is between the outer first surface of the lens 210 and the most distant of the at least one image 230 (e.g., 230a). The numbers in Table 1 were obtained using Equation 1 and simple trigonometry, corresponding to the general geometries of FIG. 2, FIG. 3, and FIG. 4. The examples shown in FIG. 2, FIG. 3, and FIG. 4 specifically correspond to the first line of Table 1, which is for lenses of 3×3 pixels at 600 dpi resolution, as explained above.

TABLE 1

| | | | | | Lens | | Clear |
|---|---|---|---|---|---|---|---|
| | | | | | height | Substrate | layer |
| | | | | | above | thickness | thickness |
| Lens | Width | L | R₁ | R₂ | substrate | (min) | (max) |
| (pixels) | (microns) | (microns) | (microns) | (microns) | (microns) | (microns) | (microns) |
| 3 × 3 | 127.0 | 253.1 | 89.8 | 163.3 | 26.3 | 179.0 | 47.8 |
| 4 × 4 | 169.3 | 337.4 | 119.7 | 217.7 | 35.1 | 238.6 | 63.8 |
| 5 × 5 | 211.7 | 421.8 | 149.7 | 272.1 | 43.8 | 298.3 | 79.7 |

In one embodiment of the invention, as shown in FIG. 2, a second image 230b is printed on the flat plane 300 on a second (lower) side of a transparent substrate 500 and covered with the layer of clear toner 240 upon which a first image 230a is printed. In this example, lens 200 is 26.3 microns in height, as shown in Table 1. If the second image as shown in FIG. 2 is at the intersection of loci of foci 220 and the line of sight 430 for the viewing angle of 30 degrees, the thickness of the clear toner layer is approximately R₂−R₂ cos(30)=21.9 microns and the thickness of the transparent substrate is L−26.3−21.9=204.9 microns. The lens array 100 is printed on the first (upper) side of substrate 500.

The image shown in FIG. 2 may be printed by a 5, 6 or more color prints by the following process. Image 230b is printed on a second side of a transparent substrate 500. In this case, image 230b can consist of 3 or 4 color separations or other similar separations that may use a gray scale, optionally followed by a white separation 232b, and flat, parallel surface 300 will be immediately adjacent substrate 500. A clear toner layer 240 is printed on image 230b and the second side of transparent substrate 500. The image is fused and the substrate with the image is passed through the printer a second time. Image 230a is printed on the flat, parallel surface 310 of the clear toner layer 240, optionally with a backing layer of white toner 232a applied to image 230a, and the image is fused. Image 230a is primarily viewed along line of sight 400 and image 230b is primarily viewed along line of sight 430. In the illustrated embodiment, the image 230b is substantially parallel to the image 230a. Image 230a can significantly overlap image 230b and white toner layer 232a can overlap both image 230a and 230b. The substrate with the image is passed through the printer a third time, and the lens array 100 is printed in register with the at least one color image 230a and 230b. Optionally, a white or neutral color toner layer 102 is printed between lenses 200, and the image is fused. A backing layer 380 of clear, white, gray or another neutral color can also be added and fused.

In an alternate embodiment, an additional layer of clear toner (not shown) is deposited on the substrate, and the image (e.g., 230b is printed on that additional layer of toner).

In another embodiment of the invention, as shown in FIG. 3, a layer of clear toner 240 is printed on a second (lower) side of transparent substrate 500. Layer 240 contains the surfaces 320, 330, and 340 that are tangent to loci of foci 220. At least one image 230 is printed on these surfaces. For example, image 230a is printed on surface 320, image 230b is printed on surface 340, and so forth. In this example, lens 200 is 26.3 microns in height, as shown in Table 1. To accommodate the full range of viewing angle ±45 degrees from normal, where normal is shown as line of sight 400, the maximum thickness of the clear toner layer 240 is approximately R₂−R₂ cos(45)=47.8 microns and the thickness of the transparent substrate is approximately L−26.3−47.8=179.0 microns. The lens array 100 is printed on the first (upper) side of substrate 500.

The image shown in FIG. 3 may be printed by a 5, 6, or more color printer according to the following process. Clear toner layer 240, which varies in thickness in this example, as shown in FIG. 3, is printed on a second side of a transparent substrate 500. The at least one color image 230 is printed on the approximately flat tangent surfaces 320, 330, and 340 of clear toner layer 240. For example, image 230b can consist of 3 or 4 color separations, or other similar separations that may use a gray scale, optionally followed by a white separation 232b printed on surface 340, which is tangent to loci of foci 220. The clear toner layer 240, image 230a, image 230b, and so forth may be printed in one pass through the printer, and can have individual white backing layers or a single white backing layer 232a, as shown in FIG. 3. The image is fused and the substrate with the image is passed through the printer a second time. The lens array 100 is printed in register with the at least one color image 230a and 230b). Optionally, a white or neutral color toner layer 102 is printed between lenses 200, and the image is fused. A backing layer 380 of clear, white, gray or another neutral color may also be added and fused. Image 230a is primarily viewed along line of sight 400 and image 230b is primarily viewed along line of sight 430. Image 230a may abut image 230b and white toner layer 232a may overlap both image 230a and 230b.

In another embodiment of the invention, as shown in FIG. 4, a layer of clear toner 240 is printed on a second (lower) side of transparent substrate 500. Layer 240 contains the surface 350 that is a curved surface essentially congruent to loci of foci 220. At least one image 230 is printed on surface 350. For example, image 230a is printed on a portion of surface 350 and image 230b is printed on an adjacent section of surface 350, and so forth. In this example, lens 200 is 26.3 microns in height, as shown in Table 1. To accommodate the full range of viewing angle ±45 degrees from normal, where normal is shown as line of sight 400, the maximum thickness of the clear toner layer 240 is approximately R₂−R₂ cos(45)=47.8 microns and the thickness of the transparent substrate is approximately L−26.3−47.8=179.0 microns. The lens array 100 is printed on the first (upper) side of substrate 500.

The image shown in FIG. 4 may be printed by a 5, 6, or more color printer according to the following process. Clear toner layer 240, which varies in thickness in this example, as shown in FIG. 4, is printed on a second side of a transparent substrate 500. The at least one color image 230 is printed on the curved surface 350 of clear toner layer 240. For example, image 230b may consist of 3 or 4 color separations, or other similar separations that may use a gray scale, optionally followed by a white separation 232b (not shown) printed on surface 350, which is congruent to loci of foci 220. The clear toner layer 240, image 230a, image 230b, and so forth may be printed in one pass through the printer, and may have individual white backing layers (not shown) or a single white backing layer 232a, as shown in FIG. 4. The image is fused and the substrate with the image is passed through the printer a second time. The lens array 100 is printed in register with the at least one color image 230, or 230a and 230b. Optionally, a white or neutral color toner layer 102 is printed between lenses 200, and the image is fused. A backing layer 380 of clear, white, gray or another neutral color may also be added and fused. Image 230a is primarily viewed along line of sight 400 and image 230b is primarily viewed along line of sight 430. Image 230a may abut image 230b or be a continuation of image 230b to make a single image, and white toner layer 232a may overlap both image 230a and 230b.

In FIG. 2, FIG. 3, and FIG. 4 the at least one color image 230 may consist of two or more separate images that are each observable when viewed from distinct viewing angles, two or more related images that form a motion image that appears to move when viewed from different, distinct viewing angles, and portions of an image that makes a single 3-D image when viewed through lens array 100. The separate images may be an image and its magnification, text in two or more different languages, two or more different scenic views on a postcard, two different frames of a cartoon, or any two or more related or unrelated images that are desired. The separate images can also be similar images that produce an image with a 3-D effect when viewed.

The embodiments of the invention described above may be used with a preformed lens array, or a pre-formed backing layer onto which a lens array is printed. Although the embodiments of the invention discussed above are described in connection with printing on a single transparent substrate, it is to be understood that other embodiments including multiple sheets of transparent substrate laminated together are also contemplated.

For example, for FIG. 2, second image(s) 230b and 232b (if desired) are printed on a second (lower) side of a first transparent substrate 500 which contains lens array 100 on its first (upper) side. First image(s) 230a and 232a (if desired) are printed on the second (lower) side of a second transparent substrate that is used instead of clear toner layer 240. The first transparent substrate and the second transparent substrate are co-joined and laminated. Although good registration is required for the lens array and the second image, requirements for registration of the first image and the second image on the opposite side of the first transparent substrate are significantly less stringent. In particular, the second image 230b and first image 230a may overlap. This method enables the use of small lenses in the lens array that are only a few pixels wide.

In one embodiment, a method of producing a lens array image includes applying a first image on a second side of a substrate (at least a portion the first image is on a first plane), applying a second image on the second side of the substrate (at least a portion the second image is on a second plane, which is different than the first plane), applying a first lens to a first side of the substrate, and applying a second lens to the first side of the substrate. The first image is in focus when viewed from a first viewing angle through a respective one of the first and second lenses. The second image is in focus when viewed from a second viewing angle through a respective one of the first and second lenses. In one embodiment, the first plane intersects a first location of a plurality of loci of foci, and the second plane intersects or is tangent to a second location of the plurality of loci of foci.

A first toner (e.g., a clear toner) layer is applied on the second image and the substrate. The first image is applied to the first toner layer. In the illustrated embodiment, applying the first image includes applying four color separations on the clear first toner layer, and applying the second image includes applying four color separations on the second side of the substrate. A separation layer is applied on a side opposite of a side of the second image applied to the substrate. A backing layer is applied on a side opposite of a side of the first image applied to the clear first toner layer. A second toner layer is applied on the first side of the substrate between lenses of the array. A backing layer is applied on one of the images.

In another embodiment, a clear toner layer is applied to the second side of the substrate. A toner layer may also be applied on the first image, the second image, and the substrate. Respective separation layers are also applied to at least one of the first image and the second image.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

The invention has been described in detail with particular reference to certain preferred embodiments thereof, but it will be understood that variations and modifications can be effected within the spirit and scope of the invention.

What is claimed is:

1. A lens array image, comprising:
a substrate;
a first lens on a first side of the substrate;
a second lens on the first side of the substrate, the first and second lenses forming a lens array;
respective first image segments at the second side of the substrate, each of the first image segments being in focus when viewed from a first viewing angle through a respective one of the first and second lenses; and
respective second image segments at a second side of the substrate, each of the second image segments being in focus when viewed from a second viewing angle through a respective one of the first and second lenses, at least a portion of each of the first image segments being on a first plane, at least a portion of the respective second image segments being on a second plane, and the first plane being different than the second plane.

2. The lens array image as set forth in claim 1, wherein respective first sides of the first and second lenses are on the first side of the substrate, the lens array image further comprising:
a separation layer on a second side of at least one of the first and second image segments.

3. The lens array image as set forth in claim 1, wherein:
the substrate is transparent.

4. The lens array image as set forth in claim 1, wherein:
the first image segments are substantially parallel to the second image segment.

5. The lens array image as set forth in claim 4, further comprising:
a clear toner layer between the first and second image segments.

6. The lens array image as set forth in claim 4, further comprising:
respective surfaces of the first image segments are tangent to a loci of foci of the respective one of the first and second lenses; and
respective surfaces of the second image segments intersect the loci of foci of the respective one of the first and second lenses.

7. The lens array image as set forth in claim 1, wherein respective surfaces of the first image segments and the second image segments are tangent to a loci of foci of the respective one of the first and second lenses.

8. The lens array image as set forth in claim 1, wherein respective surfaces of the first image segments and the second image segments are curved and substantially in alignment with a loci of foci of the respective one of the first and second lenses.

9. The lens array image as set forth in claim 1, wherein the first viewing angle is normal to the lens array ±15 degrees; and
the second viewing direction is 30 degrees from the normal ±15 degrees.

10. The lens array image as set forth in claim 1, wherein the first lens and the second lens are cylindrical or spherical shaped.

11. The lens array image as set forth in claim 1, wherein respective lower surfaces of the first and second lenses are between respective upper surfaces and loci of foci of the first and second lenses.

12. The lens array image as set forth in claim 1, wherein the first plane intersects and/or is adjacent to a first location of a plurality of loci of foci; and
the second plane intersects a second location of the plurality of loci of foci.

13. A method of producing a lens array image, the method comprising:
applying a first image on a second side of a substrate, at least a portion the first image being on a first plane;
applying a second image on the second side of the substrate, at least a portion the second image being on a second plane, which is different than the first plane;
applying a first lens to a first side of the substrate; and
applying a second lens to the first side of the substrate, the first image being in focus when viewed from a first viewing angle through a respective one of the first and second lenses, and the second image being in focus when viewed from a second viewing angle through a respective one of the first and second lenses.

14. The method of producing a lens array image as set forth in claim 13, further comprising:
applying a clear first toner layer on the second image and the substrate; and
applying the first image to the clear first toner layer.

15. The method of producing a lens array image as set forth in claim 14, wherein:
applying the first image includes:
applying four color separations on the clear first toner layer; and
applying the second image includes:
applying four color separations on the second side of the substrate.

16. The method of producing a lens array image as set forth in claim 14, further comprising at least one of
applying a separation layer on a side opposite of a side of the second image applied to the substrate; and
applying a backing layer on a side opposite of a side of the first image applied to the clear first toner layer.

17. The method of producing a lens array image as set forth in claim 14, further comprising:
applying a second toner layer, on the first side of the substrate, between lenses of the lens array.

18. The method of producing a lens array image as set forth in claim 14, further comprising:
applying a backing layer on one of the images.

19. The method of producing a lens array image as set forth in claim 13, further comprising:
applying a clear toner layer to the second side of the substrate.

20. The method of producing a lens array image as set forth in claim 14, wherein applying the second image further comprising:
applying the second image to the second side of the substrate; and
applying the first image and the second image in one pass through the printer.

21. The method of producing a lens array image as set forth in claim 13, further comprising:
applying a toner layer on the first image, the second image, and the substrate.

22. The method of producing a lens array image as set forth in claim 21, further comprising before applying the toner layer:
applying respective separation layers to at least one of the first image and the second image.

23. The method of producing a lens array image as set forth in claim 13:
wherein applying the first image includes:
ensuring the first plane intersects or is tangent to a first location of a plurality of loci of foci; and
wherein applying the second image includes:
ensuring the second plane intersects a second location of the plurality.
